(19) United States
(12) Patent Application Publication
(10) Pub. No.: US 2013/0086030 A1
(43) Pub. Date: Apr. 4, 2013

(54) METHOD FOR SEARCH ENGINES TO RANK FORUMS AND DISCUSSION BOARDS

(71) Applicant: Giotto De Filippi, Milano (IT)

(72) Inventor: Giotto De Filippi, Milano (IT)

(21) Appl. No.: 13/251,230

(22) Filed: Oct. 1, 2011

(51) Int. Cl. G06F 17/30

(52) U.S. Cl. 707/706; 707/723; 707/E17.108

(57) ABSTRACT

A search engine method, performed by one or more server devices, for improving relevancy in ranking search results for forums and discussion boards. In one aspect of the invention, the method weights selected posts using one or more parameters for forums and discussion boards, where a post to a forum or a discussion board has certain properties that are typically associated with forums and discussion boards. Unlike, other methods, the disclosed method is largely content driven, and the method drills down to estimate relevancy, and the posts properties are analyzed to as to how much they should contribute to the ranking.

### BACKGROUND OF THE INVENTION

1. Field of the Invention

The present invention relates to search engines and more specifically to a method for ranking indexed forums and discussion boards, where the method provides a more relevant ranking than prior search engine methods.

2. Prior Art

Search engines are designed to provide relevant results from a database (which often is the World Wide Web) according to the search query that a visitor performs. In the early stages of its use, Internet search engines were using simple algorithms that were based solely on on-page factors. In order to rank different webpages these search engines analyzed the webpage itself and used various algorithms to decide how to rank the webpage. These algorithms took into account only factors that are on the webpage itself, for example how many times keywords appear on the webpage, where the words appear on the webpage, if the keyword(s) is in the title of the webpage, how old the webpage is, how distributed the keywords are, et etcetera. These algorithms were relatively easy to manipulate by webpage owners, since all the factors affecting the ranking were on the webpage itself. It was easy for the owner of the webpage to, make changes and adjust his/her webpage to increase its ranking in the search engine results. As a consequence of the manipulation to achieve higher rankings, it can be argued that there was a deterioration in the quality of the search.

The next evolution of the search engine algorithm was to take into account not only the on-page factors, but also using backlink information (information from linking webpages that contains backlinks to a webpage being ranked) to assist in determining the relevancy of the webpage. In addition to/or instead of the content of the webpage the ranking algorithm considered the relevance of anchor text (the visible text in a hyperlink) of the backlinks. Anchor text is weighted in the search engine algorithms, because the linked text is usually relevant to the landing page (the hyper linked webpage). Presuming that the objective of search engines is to provide highly relevant search results, it was found that anchor text can be useful. The tendency is, more often than not, to hyperlink words relevant to the landing page.

In assessing the rank, the search engines often use the number of backlinks that a website has for determining that website's search engine ranking. For example, Google's PageRank algorithm uses backlinks to help determine a site's rank.

A further improvement in search engines ranking is described in U.S. Pat. No. 7,058,628 to Lawrence Page. Page teaches a method that assigns ranking scores to nodes in a linked database, such as any database of documents containing citations, the world wide web or any other hypermedia database. The rank assigned to a document is calculated from the contribution of the documents citing it. In addition, the rank of a document is calculated using a probability constant that a browser/visitor will randomly jump to the document.

A weakness of ranking webpages largely on the basis of hyperlinks, and in particular backlinks, is that the rank of a page can be significantly decreased if the linked page adds hyperlinks to other pages. The more hyperlinks the referring page has, the lower the weight of any individual hyperlinks, as the ranking is divided by a larger number of choices (hyperlinks) that the searcher can choose from. This is, demonstrated by examining the example given in U.S. Pat. No. 7,058,628, which calculates a probability function. Search engines index all webpages without much consideration for the type of content that is being indexed ('blogs, forums, ecommerce sites, newspapers, etc. . . . ). The prevailing algorithm used by the major search engine is called PageRank. The PageRank algorithm rank pages by looking at the number and the “strength” of the links that are pointing to a specific page and which keywords are used in the anchor text in order to determine how relevant a certain page is for a certain keyword. Additionally, the owners of webpages often manipulate the search engine results by persuading other webpages to link to them, purchasing backlinks, exchanging backlinks with other websites, et etcetera.

The result of this method of ranking, in the inventor's opinion, typically produces very standardized and static search results. This is the case, in part, because it takes time to create links especially when a webpage occupies a highly ranked position, because certain keywords prevent it from being easily changed in rank. Also, webpages largely having most long tail information (for example a post on a forum or a discussion board (blogs)) will probably have few, if any incoming links. Therefore, forums and the like will usually have a low ranking, and therefore they will be hard to find.

There are some lesser known search engines, for example omgili.com (e.g. Oh my God I love it and boardreader.com) geared towards blogs, forums, ecommerce sites, newspapers, et etcetera. These search engines typically still index all webpages without consideration for the content. Omgili.com does offer the ability of filtering results by timeframe, number of replies and number of discussing users. While filtering may reduce the number of results, it need not change the ranking.

### SUMMARY OF THE INVENTION

The invention is a search engine method, performed by one or more server devices, for improving relevancy in ranking search results for forums and discussion boards. In one aspect of the invention, the method weights selected posts using one or more parameters for forums and discussion boards, where a post to a forum or a discussion board has certain properties that are typically associated with forums and discussion boards. Unlike, other search engine methods, the disclosed method is largely content driven, and the method drills down to estimate relevancy, and the posts are analyzed to as to how much they should contribute to the ranking.

The invention further includes one or more non-transitory memory devices that store instructions executable by at least one processor to perform a method for improving relevancy in ranking search results for forums and discussion boards by weighting selected posts using one or more parameters.

The invention, in another aspect, is a method for improving relevancy in ranking of search results for forums and discussion boards and performed by one or more server devices running a search query on a search engine, where a user selects how much a parameter of a post on a forum and on a discussion board is weighted, which in turn improves the relevancy in ranking.

### BRIEF DESCRIPTION OF THE DRAWINGS

The foregoing and other objects will become more readily apparent by referring to the following detailed description and to the appended drawings in which:

FIG. 1 is an illustrative embodiment of an invented method for improving relevancy in ranking of search results for forums and discussion boards and performed by one or more server devices running a search query on a search engine, where a user selects how much a parameter of a post on a forum and on a discussion board is weighted, which in turn improves the relevancy in ranking.

### DETAILED DESCRIPTION

Forums and discussion boards (blogs) can be more or less relevant, and preferably a search engine should rank them accordingly, where websites that are most relevant should be shown first. Advertisers will no doubt still have a portion of the viewing area, but search engines should have a capability to need to hone in on forums and discussion boards, ranking them in a way that is more content driven and according to properties that can be determinative as to the quality of the posts. Forums are largely text or posts, where posts have certain properties, for example: a poster's name is usually a nickname for an author, a poster's reputation is based on an algorithm that is usually a reflection of how readers rate a post and the number of posts. The poster's reputation is usually not limited to an area of expertise in the conventional sense, and within a specific forum the poster's reputation can be a function of the sensibilities of contributors to the forum. Examples of reputation include number of stars, titles, and other quantitative terms.

The invented search engine, method can furthermore rank forums and discussion boards according to one or more of the following parameters including: a number of posts by the poster, a number of replies to a specific, thread, a number of replies to posts posted by a replying poster, a replying poster's reputation (see definition of reputation above), a total number of posts by replying posters to the specific thread, a time interval for the specific thread between an original post and a last reply, determination of how recent is the original post, a determination of how recent is the last reply, and a total count of posts (original plus replies). In the method, where there are multiple repliers to an initiated thread, the method employs an algorithm to cumulatively weight the contributors within a specific forum, and comparatively develop a ranking order amongst comparable forums. Keywords would of course typically be used to narrow in on the subject matter/content.

In some cases, an original poster's geographical location can be important. as well as a geographical location of posters that made replies. For example if a user is searching “best lobster restaurant in NY” the forum search engine could use the following parameters to rank the forum posts: 1) Most recent threads preferred (a restaurant, may have been good in the past, but maybe is not now); 2) Good reputation of poster (he/she is well respected in the forum); 3) Large number of replies. The user conducting the search can scan over the results (hits) to ensure many people agree with the original poster. The user may also learn details, for example maybe the lobster is very good but service is average. Using a major search engine for this query filtered for blogs the results were 1) a story about “East Village gay bar the Phoenix had been sold to new owners and that they were considering making the bar less gay centric; 2) The Portofino Grille, which sits on First Avenue between 63rd and 64th Streets; and 3) Zagat Names Upper West Side Luke's Lobster One Of “New York's Eight Best Seafood Restaurants”. No forums, discussions boards were listed on the first page of the results.

The search engine can also offer to the user the option to choose which parameters to take into account, and how to weight the selected parameters. For example the user might decide to give a lot of weight to the reputation of a poster, but not really care if the thread is recent or if there has been many replies to that thread. The user might select this combination of parameters for subjects that are not particularly time sensitive, such as a search for the “best painting by Vincent van Gogh.”

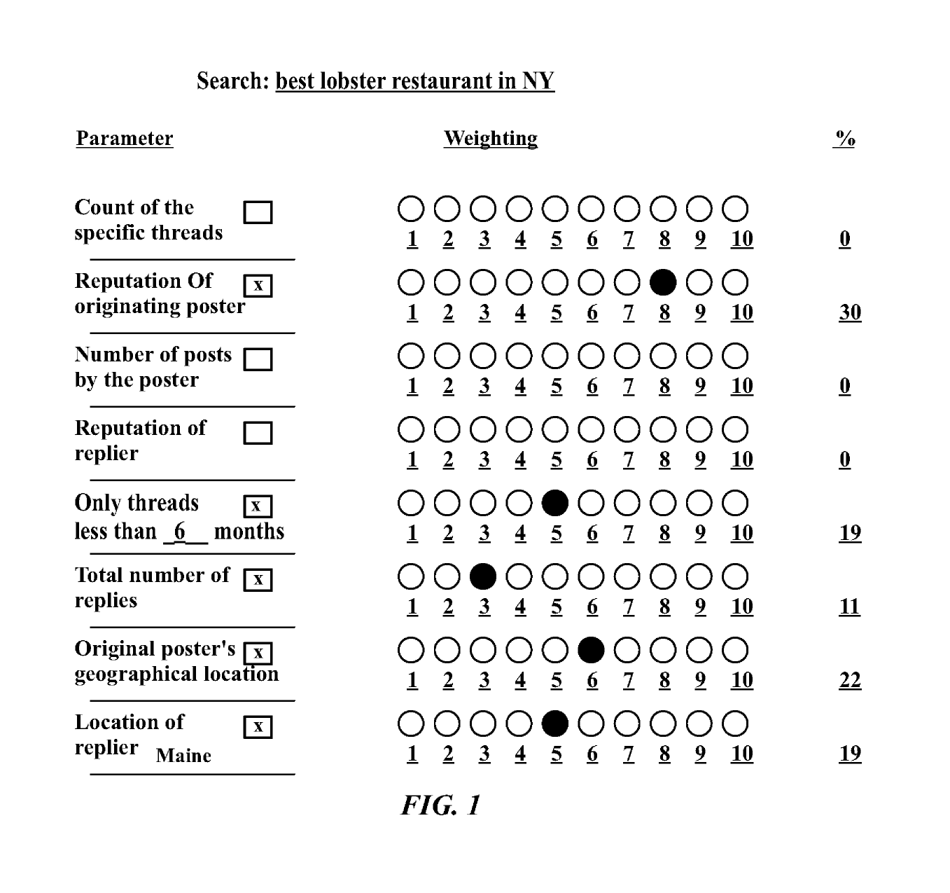

An example of the first query, “best lobster restaurant in NY”, is shown in FIG. 1. Five parameters of eight parameters are selected as marked by X's in the box, and weighted as selected by filled circles above a number 1-10, and relatively as a percentage of the cumulative total of 100% (so that the user can keep track of the weighting, where the weighting is expressed as a percentage). If the parameter box is not selected, the user cannot select a weighting value. As is evident from the FIGURE the reputation of the poster is selected and the weighting is an eight. Only threads that are less than six months old will be ranked high, unless there is no competition. The user entered time period. The user in the illustrated has the option of selecting threads that are relatively new to threads that have been around for years. If not selected then the length of time that the thread was generated is not taken into consideration. As previously discussed, since restaurants can go out-of-business fairly frequently, a relatively short thread time is appropriate. The total number of replies was selected, but not heavily weighted, as “Best” is a relatively subjective term. The poster's geographic location is relevant because the nearer the origin poster is to the restaurant, probably the better is his knowledge, especially if he/she has a strong enough opinion to post it online. The geographic location can be determined from the IP address. For instance, the IP address 75.183.157.200 is in Hilton Head, S.C. Members of a forum will frequently include an address (city, state) along with their username in a forum. In the example, the IP address of the poster and replier have similar geographic locations, and were weighted similarly. If the same can be said for the replier, then search engine user wanted the poster and replier to be weighted similarly. The method can include additional modifying elements such as coefficients and exponents, which can affect the ranking. For instance, in the case where geographic location is a ranking parameter, then a preferred geographic location could be factored in. For example, additional weighting can be given to a forum having members who are from Maine, because as a poster from Maine, the poster probably has specific knowledge about lobsters, even though they are not local (e.g., proximate to NY city).

The method is performed by one or more server devices, for improving relevancy in ranking search results for forums and discussion boards by weighting using one or more parameters, where a parameter of a post is one or more of the following: 1) a quantification of a poster being reputable, where quantification can include recognition within the forum in an area of expertise; 2) contribution by the poster, as measured by the number of originating posts (threads) by the poster; 3) a number of replies to a specific thread; 4) a number of replies to posts posted by a specific poster; 5) a quantification of a replying poster being reputable, where quantification can include recognition within the forum; 5) a count of posts of replying posters; 6) a time span between a first post and a last reply of the specific thread; 7) a count of the specific threads; 8) a time span between the last reply and a current date; 9) a geographical location of the poster; and 10) a geographical location of the replying poster.

In a second embodiment, there are one or more non-transitory memory devices that store instructions executable by at least one processor to perform a method for improving relevancy in ranking search results for forums and discussion boards by weighting one or more parameters, where a parameter of a post includes one or more of the following: 1) a quantification of a poster as being reputable, where quantification can include credentials within the forum or discussion board; 2) a number of posts by the poster; 3) a number of replies to a specific thread; 4) a number of replies to posts posted by a specific poster; 5) a quantification of a replying poster being reputable, where quantification typically is determined by a consensus analysis of the members' opinions (for instance like or dislike/agree or disagree with); 5) a count of posts of replying, posters; 6) a time span between a first post and a last reply of the specific thread; 7) a count of the specific threads; 8) a time span between the last reply and a current date; 9) a geographical location of the poster; and 10) a geographical location of the replying poster.

Another embodiment is a method for improving relevancy in ranking of search results for forums and discussion boards and performed by one or more server devices running a search query on a search engine, where a user selects how much a parameter of a post on a forum and on a discussion board is weighted, which, in turn improves the relevancy in ranking, where said parameter of the post is one or more of the following: 1) a quantification of a poster being reputable, where quantification typically includes recognition (a rating by the forum); 2) a number of posts by the poster; 3) a number of replies to a specific thread; 4) a number of replies to posts posted by a specific poster; 5) a quantification of a replying poster being reputable, where quantification typically includes recognition (a rating by the forum); 5), a count of posts of replying posters; 6) a time span between a first post and a last reply of the specific thread; 7) a count of the specific threads; 8) a time span between the last reply and a current date; 9) a geographical location of the poster; and 10) a geographical location of the replying poster.

The method for improving relevancy in ranking of search results for forums and discussion boards and performed by one or more server devices running the search query on the search engine can include additional modifying elements, such as coefficients and exponents, which can affect the ranking. For instance, in the case where a geographical location of the replying poster is a ranking parameter, then a preferred geographic location could be factored in. For example, additional weighting can be given to a forum having members who are from a specific geographic location, because as a poster from that location the poster probably has specific knowledge about the thread. This would be particularly useful in forums where cultural influences were highly relevant to the thread.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

It will be clear to one skilled in the art that the above embodiments may be altered in many ways without departing from the scope of the invention. Accordingly, the scope of the invention should be determined by the following claims and their legal equivalents.

What is claimed is:

1. A method performed by one or more server devices, for improving relevancy in ranking search results for forums and discussion boards by weighting using one or more parameters, where a parameter of a post is comprised of one or more of the following:
a quantification of a poster being reputable, where
quantification can include credentials;
a number of posts by the poster;
a number of replies to a specific thread;
a number of replies to posts posted by a specific poster;
a quantification of a replying poster being, reputable, where
quantification can include credentials;
a time span between a first post and a last reply of the specific thread;
a count of the specific threads;
a time span between the last reply and a current date;
a geographical location of the poster; and
a geographical location of the replying poster.

2. The method according to claim 1, wherein the parameter further comprises:
a number of posts by the poster.

3. The method according to claim 1, wherein the parameter further comprises:
a count of posts of replying posters.

4. The method according to claim 1, wherein the parameter further comprises:
a quantification of a poster being reputable, where quantification is based on recognition within the forum.

5. One or more non-transitory memory devices that store instructions executable by at least one processor to perform a method comprising a method for improving relevancy in ranking search results for forums and discussion boards by weighting selected using one or more post parameters, where a parameter of a post is comprised of one or more of the following:
a quantification of a poster being reputable, where
quantification can include credentials;
a number of posts by the poster;
a number of replies to a specific thread;
a number of replies to posts posted by a specific poster;
a quantification of a replying poster being reputable, where
quantification can include credentials;
a count of posts of replying posters;
a time span between a first post and a last reply of the specific thread;
a count of the specific threads;
a time span between the last reply and a current date;
a geographical location of the poster; and
a geographical location of the replying poster.

6. The one or more non-transitory memory devices as claimed in claim 5, wherein the parameters are selected by a user conducting a search.

7. The one or more non-transitory memory devices as claimed in claim 5, wherein the weighting factors are selected by a user conducting a search.

8. A method for improving relevancy in ranking of search results for forums and discussion boards and performed by one or more server devices running a search query on a search engine, where a user selects how much a parameter of a post on a forum and on a discussion board is weighted, which in turn improves the relevancy in ranking, where said parameter of the post is comprised of one or more of the following:
a quantification of a poster being reputable, where
quantification can include credentials;
a number of replies to a specific thread;
a number of replies to posts posted by a specific poster;
a quantification of a replying poster being, reputable, where
quantification can include credentials;
a time span between a first post and a last reply of the specific thread;
a count of the specific threads;
a time span between the last reply and a current date;
a geographical location of the poster; and
a geographical location of the replying posters.

9. The method according to claim 8, wherein the parameter further comprises:
a number of posts by the poster.

10. The method according to claim 8, wherein the parameter further comprises:
a count of posts of replying posters.

11. The method according to claim 8, wherein the parameter further comprises:
a quantification of a poster being reputable, where quantification is based on recognition within the forum.

12. The method according to claim 1, wherein ranking of the results of the search query on the search engine comprises:
one or more modifying elements which change an order of the ranking.

13. The method according to claim 5, wherein ranking of the results of the search query on the search engine comprises:
one or more modifying elements which change an order of the ranking.

14. The method according to claim 8, wherein ranking of the results of the search query on the search engine comprises:
one or more modifying elements which change an order of the ranking.
